(19) United States
(12) Patent Application Publication
(10) Pub. No.: US 2026/0091597 A1
(43) Pub. Date: Apr. 2, 2026

(54) AUXILIARY MEMBER

(71) Applicant: BROTHER KOGYO KABUSHIKI KAISHA, Nagoya (JP)

(72) Inventor: Tetsuo ITO, Nagoya (JP)

(21) Appl. No.: 19/410,583

(22) Filed: Dec. 5, 2025

Related U.S. Application Data
(63) Continuation of application No. PCT/JP2024/022542, filed on Jun. 21, 2024.

(30) Foreign Application Priority Data
Jun. 29, 2023 (JP) 2023-106702

(51) Int. Cl. B41J 11/06; B41J 3/407; B41J 11/14

(52) U.S. Cl. CPC B41J 11/06; B41J 3/4078; B41J 11/14

(57) ABSTRACT

An auxiliary member includes a sheet extending in a plane intersecting a first direction, a first support member extending in a second direction, a second support member extending in the second direction, and a third support member extending toward a single point in a third direction from both the first support member and the second support member. The first support member is disposed at an end of the sheet in a third specific direction. The second support member is disposed at an end of the sheet in a third opposite direction. The first, second, and third support members support the sheet and having a higher rigidity than the sheet.

### REFERENCE TO RELATED APPLICATIONS

This application is a continuation application of International Application No. PCT/JP2024/022542, filed June 21, 2024, which claims priority from Japanese Patent Application No. 2023-106702, filed on June 29, 2023. The entire content of the priority application is incorporated herein by reference.

### BACKGROUND ART

An inkjet textile print device includes a platen and an ejection head. A print medium is placed on the platen. The platen moves between a position where the print medium is placed on the platen and a position where the platen faces the ejection head. The ejection head ejects ink onto the print medium on the platen.

### SUMMARY

In the above-described inkjet textile print device, ink ejected from the ejection head may adhere to the platen. In order to suppress ink from adhering to the platen, it is conceivable to place a sheet between the platen and the print medium. In this case, for example, if the sheet is displaced with respect to the platen during platen movement, the print medium will be displaced with respect to the sheet, resulting in a possibility that the actual image printed on the print medium will deviate from the intended position.

Embodiments of the broad principles derived herein provide an auxiliary member that contributes to suppressing misalignment of a sheet with respect to a platen.

The present specification discloses, for example, the following aspects.

One of the aspects of the present disclosure relates to an auxiliary member. The auxiliary member is configured to be mounted to a platen. The platen is configured to be conveyed between a set position and a print position. The set position is a position where a print surface of a print medium is placed on a placement surface that is an upper surface of the platen. The print position is a position where the placement surface of the platen faces, in an up-down direction, a nozzle surface of an inkjet head, with the print surface of the print medium between the placement head of the platen and the nozzle surface of the inkjet head. The auxiliary member includes a sheet extending in a plane intersecting a first direction. The auxiliary member includes a first support member extending in a second direction intersecting the first direction. The first support member is disposed at an end of the sheet in a third specific direction. The third specific direction is one of a third direction intersecting the first direction and the second direction. The first support member supports the sheet and has a higher rigidity than the sheet. The auxiliary member includes a second support member extending in the second direction. The second support member is disposed at an end of the sheet in a third opposite direction. The third opposite direction is opposite to the third specific direction in the third direction. The second support member supports the sheet and has a higher rigidity than the sheet. The auxiliary member includes a third support member extending toward a single point in the third direction from both the first support member and the second support member. The single point is disposed between the first support member and the second support member. The third support member supports the sheet and has a higher rigidity than the sheet. The auxiliary member is configured to be mounted to the platen with the first direction oriented along the up-down direction. The sheet is disposed between the placement surface of the platen and the print surface of the print medium in the up-down direction, in a state where the auxiliary member is mounted to the platen. The first support member, the second support member, and the third support member are positioned below the sheet, in the state where the auxiliary member is mounted to the platen.

According to the above-described aspect, the first support member, the second support member, and the third support member are each positioned below the sheet in the state where the auxiliary member is mounted to the platen. Therefore, when the sheet attempts to shift relative to the platen, the first support member, the second support member, or the third support member comes into contact with the platen. Since the rigidity of the first support member, the second support member, and the third support member is higher than that of the sheet, when each support member comes into contact with the platen, misalignment of the sheet with respect to the platen is more likely to be suppressed, as compared to the case where the rigidity of the first support member, the second support member, and the third support member is lower than that of the sheet. Therefore, the auxiliary member contributes to suppressing misalignment of the sheet with respect to the platen.

### BRIEF DESCRIPTION OF DRAWINGS

FIG. 1 is a perspective view of a printer as seen from the front left upper side.

FIG. 2 is a schematic view of a cross-section taken along line A-A in FIG. 1, as seen in the direction of the arrows.

FIG. 3 is a view showing an auxiliary member as seen from a Z+ direction.

FIG. 4 is a cross-sectional view of a sheet.

FIG. 5 is a view, as seen from the Z+ direction, showing a state before the auxiliary member is mounted to a platen.

FIG. 6 is a view, as seen from the Z+ direction, showing a state where the auxiliary member is mounted to the platen and a T-shirt is not yet set on the platen.

FIG. 7 is a view as seen in the Z+ direction, showing a state in which the T-shirt is set on the platen to which the auxiliary member is mounted.

FIG. 8 is a sectional view taken along line B-B as viewed in the direction indicated in FIG. 7, in the case where the platen is large.

FIG. 9 is a sectional view taken along line B-B as viewed in the direction indicated in FIG. 7, in a case where the platen is small.

### DESCRIPTION

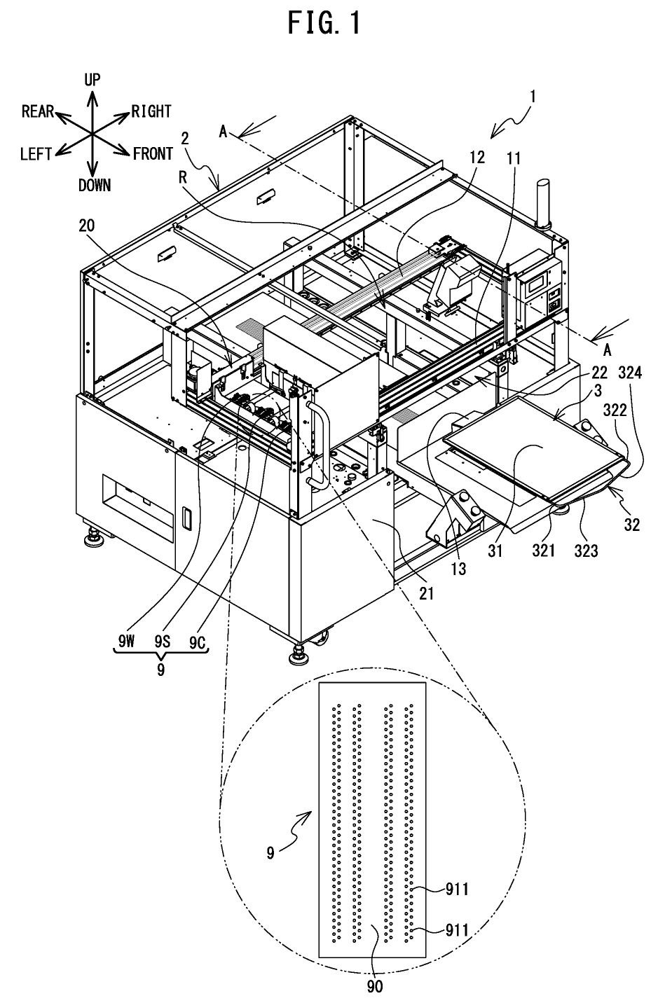

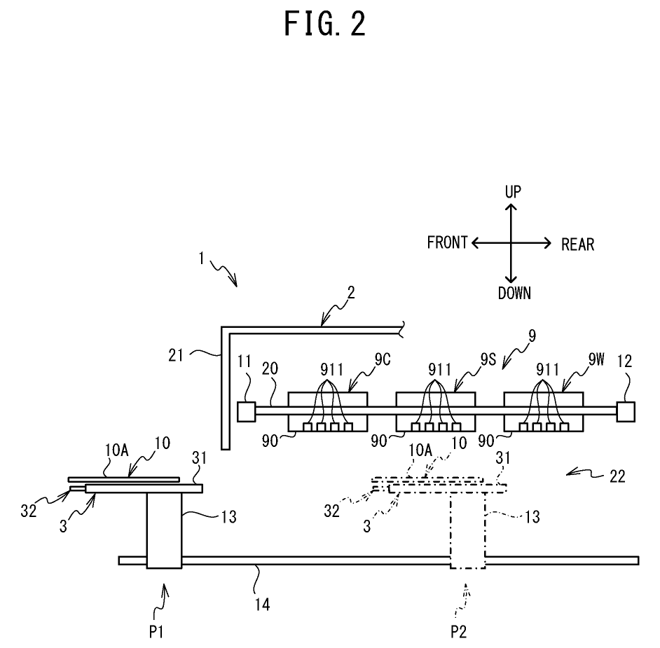

A printer 1 and an auxiliary member 5 according to an embodiment of the present disclosure will be described with reference to the drawings. In the present embodiment, the mechanical elements in the drawings indicate the actual scale. The printer 1 shown in FIG. 1 is an inkjet printer, and performs printing on a T-shirt 10 as shown in FIG. 2. The T-shirt 10 is one type of print medium. The print medium may be fabric or paper, for example, and is not limited to the T-shirt 10.

For example, printer 1 applies a pretreatment agent onto the T-shirt 10 on a platen 3, as described later, and ejects ink onto the T-shirt 10 that is wet from the pretreatment agent, thereby making it possible to perform so-called wet-on-wet printing. The printer 1 is also capable of performing so-called wet-on-dry printing, in which the printer 1 ejects ink onto the T-shirt 10 which is dry on the platen 3.

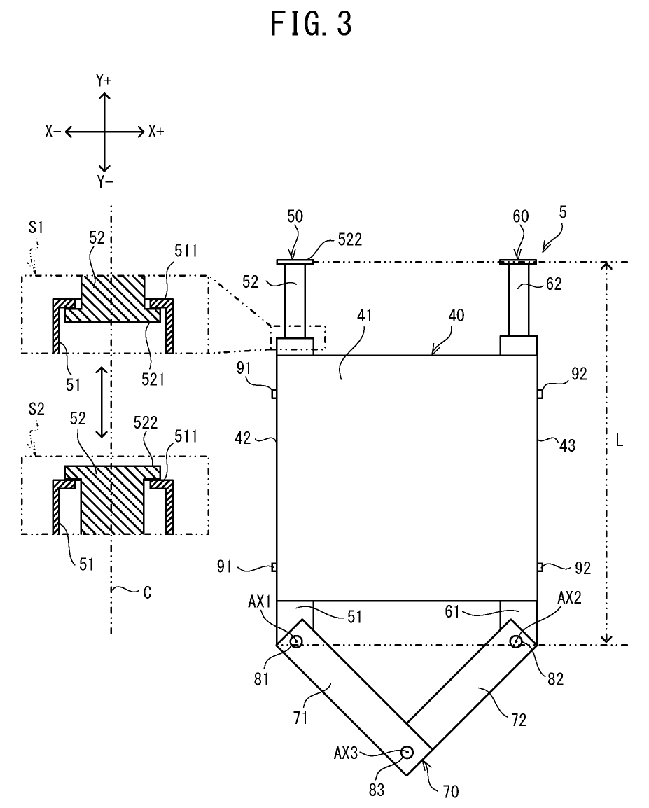

The auxiliary member 5 shown in FIG. 3 is used as an underlay for the T-shirt 10 in order to suppress the adhesion of ink to the platen 3 when printing is performed by printer 1. Furthermore, in wet-on-wet printing, since the T-shirt 10 is in a wet state, it is difficult to remove the printed T-shirt 10 from the platen 3 due to, for example, the surface tension of the liquid present between the T-shirt 10 and the platen 3. The auxiliary member 5 is used to facilitate removal of the wet T-shirt 10 from the platen 3.

The general configuration of the printer 1 will be described with reference to FIG. 1 and FIG. 2. An upward direction, a downward direction, a lower left direction, an upper right direction, a lower right direction, and an upper left direction in FIG. 1 are respectively an upper direction, a downward direction, a left direction, a right direction, a front direction, and a rear direction of the printer 1. The up-down direction of the printer 1 is the vertical direction.

As shown in FIG. 1 and FIG. 2, the printer 1 includes a housing 2, the platen 3, a shaft 14 (refer to FIG. 2), guide rails 11 and 12, a carriage 20, and inkjet heads 9. The housing 2 has a cuboid shape and includes a front wall 21. The upper portion of the housing 2 is not shown in FIG. 1. An opening 22 is formed in the housing 2. The opening 22 extends rearward from the central portion of the front wall 21.

The platen 3 is disposed inside the opening 22 when viewed from the front, and is supported by a support base 13. The platen 3 has a rectangular plate shape and extends in both the front-rear direction and the left-right direction. A placement surface 31 is formed on the upper surface of the platen 3. On the platen 3, the T-shirt 10 is positioned such that a surface of the T-shirt 10 on which an image is to be printed (hereinafter referred to as the “print surface 10A”) is placed on the placement surface 31 (refer to FIG. 2).

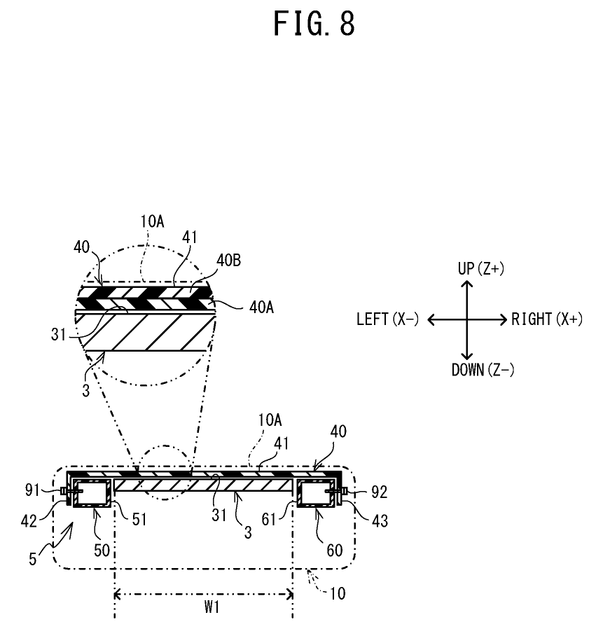

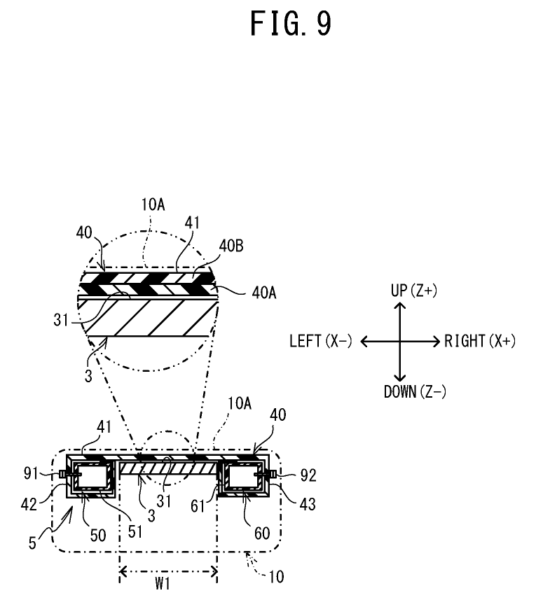

The platen 3 is detachable from the support base 13. In the present embodiment, the platen 3 is provided in two sizes: a large size whose width W1 in the left-right direction is relatively large (refer to FIG. 8), and a small size whose width W1 in the left-right direction is smaller than that of the large size (refer to FIG. 9). For example, either a large-size or a small-size platen 3 is mounted to the support base 13 depending on the size of the T-shirt 10.

As shown in FIG. 1, a support portion 32 is arranged at the front end of the platen 3. The support portion 32 includes extension portions 321, 322, 323, and 324. Each of the extension portions 321, 322, 323, and 324 is rod-shaped. The extension portion 321 extends forward from the left end of the front end of the platen 3. The extension portion 322 extends forward from the right end of the front end of the platen 3. The extension portion 323 extends forward as the extension portion 322 extends from the front end of extension portion 321 toward the right. The extension portion 324 extends forward as from the front end of extension portion 322 toward the left. The extension portions 323 and 324 are connected together at an intermediate position, between extension portions 321 and 322 in the left-right direction. The support portion 32 has a shape conforming to the shoulder portion of the T-shirt 10 and supports a portion of the T-shirt 10 that is positioned forward of the front end of the platen 3.

As shown in FIG. 2, the shaft 14 is positioned below the opening 22 and extends in the front-rear direction. The shaft 14 supports the platen 3 via the support base 13. The platen 3 is conveyed in the front-rear direction along the shaft 14 between a set position P1 and a print position P2 by the driving of a sub-scanning motor. FIG. 2 shows the platen 3 and the support base 13 located at the set position P1 with solid lines, and the platen 3 and the support base 13 located at the print position P2 with virtual lines.

The set position P1 is the position of the platen 3 when the print surface 10A of the T-shirt 10 is placed on the placement surface 31 of the platen 3 and the T-shirt 10 is set on the platen 3. In the present embodiment, in a case where the platen 3 is positioned at the set position P1, the platen 3 is positioned forward of the front wall 21. The print position P2 is the position of the platen 3 when the placement surface 31 of the platen 3 and a nozzle surface 90 of the inkjet head 9, described later, are opposed to each other in the up-down direction with the print surface 10A of the T-shirt 10 in between. In the present embodiment, in a case where the platen 3 is positioned at the print position P2, the platen 3 is positioned to the rear of the front wall 21.

As shown in FIG. 1 and FIG. 2, the guide rail 11 is arranged above the opening 22 behind the front wall 21 and extends in the left-right direction. The guide rail 12 is arranged behind the guide rail 11 and extends in the left-right direction. The carriage 20 is a plate positioned between the guide rails 11 and 12 in the front-rear direction. The carriage 20 is supported by the guide rails 11 and 12. The carriage 20 is driven by a main scanning motor to move in the left-right direction along the guide rails 11 and 12.

The inkjet heads 9, each having a cuboid shape, are mounted to the carriage 20. The enlarged view shown in FIG. 1 is a bottom view of the inkjet head 9. The nozzle surface 90 is formed on the lower surface of the inkjet head 9. The nozzle surface 90 is positioned above the placement surface 31 of the platen 3, and is exposed downward through an opening positioned in the carriage 20. Nozzles 911 are disposed on the nozzle surface 90.

The inkjet heads 9 includes a white head 9W, a color head 9C, and a pretreatment head 9S. The positional relationship among the white head 9W, the color head 9C, and the pretreatment head 9S is not limited to a specific arrangement; however, in the present embodiment, they are aligned in a single row in the order of the color head 9C, the pretreatment head 9S, and the white head 9W, from front to rear.

The white head 9W ejects white ink from the nozzles 911. The white ink is used as a base for an image to be printed or to print a color image. The color head 9C ejects color ink (cyan, magenta, yellow, or black) from the nozzles 911. The color ink is used for printing color images. The pretreatment head 9S ejects a pretreatment agent from the nozzles 911. The pretreatment agent is a base coat solution for improving fixing of the ink to the T-shirt 10 and improving color development of the ink, and is an aqueous solution containing formic acid and acetic acid, for example.

The inkjet heads 9 move together with the carriage 20 in the left-right direction. Hereinafter, a region where the movement region of the inkjet heads 9 overlaps with the movement region of the platen 3 in plan view is referred to as the “print region R” (refer to FIG. 1).

Printing by the printer 1 will now be described with reference to FIG. 2. In a case where the T-shirt 10 contains polyester, for example, wet-on-wet printing is performed by the printer 1 performing pretreatment and printing processing in that order. In a case where the T-shirt 10 includes cotton, for example, wet-on-dry printing is performed by the printer 1 performing the printing processing without performing the pretreatment. In the case of wet-on-dry printing, for example, after pretreatment is performed by a pretreatment device, the T-shirt 10 may be dried, and printing by the printer 1 may be executed on the dry T-shirt 10.

Printing by the printer 1 is performed with the inkjet heads 9 positioned in the printing region R and the platen 3 situated at the print position P2. In this state, the placement surface 31 of the platen 3 faces at least one nozzle surface 90 of the inkjet heads 9 in the up-down direction, with the print surface 10A of the T-shirt 10 in between.

During the pretreatment, the pretreatment head 9S ejects a pretreatment agent from the nozzle 911 while the carriage 20 moves in the left-right direction. The pretreatment agent ejected from the nozzle 911 of the pretreatment head 9S lands on the print surface 10A of the T-shirt 10 that is on the placement surface 31. The platen 3 moves in the front-rear direction. The pretreatment agent is applied to the print surface 10A of the T-shirt 10 by repeatedly moving the carriage 20 in the left-right direction while ejecting the pretreatment agent from the pretreatment head 9S, and moving the platen 3 in the front-rear direction. With this, the pretreatment is completed.

During the printing processing, one or both of the white head 9W and the color head 9C ejects ink from the nozzles 911 while the carriage 20 moves in the left-right direction. The ink ejected from one or both of the nozzles 911 of the white head 9W and the color head 9C lands on the print surface 10A of the T-shirt 10 that is on the placement surface 31. The platen 3 moves in the front-rear direction. An image is printed on the print surface 10A of the T-shirt 10 by repeatedly moving the carriage 20 in the left-right direction while ejecting ink from the white head 9W and the color head 9C, and moving the platen 3 in the front-rear direction. With this, the printing processing is completed.

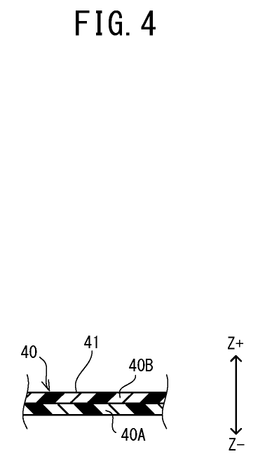

The auxiliary member 5 will now be described with reference to FIG. 3 and FIG. 4. The leftward direction, the rightward direction, the downward direction, the upward direction, the front side of the paper, and the back side of the paper in FIG. 3 are, respectively, an X- direction, an X+ direction, a Y- direction, a Y+ direction, a Z- direction, and a Z+ direction of the auxiliary member 5.

As shown in FIG. 3, the auxiliary member 5 includes a sheet 40 and support members 50, 60, and 70. The sheet 40 is flexible and includes an underlay portion 41 and extra portions 42 and 43. The underlay portion 41 extends in a planar fashion orthogonal to the Z direction, and has a rectangular shape when viewed from the Z direction. The extra portions 42 and 43 are parts of the sheet 40 other than the underlay portion 41. The extra portion 42 extends from the X- direction end of the underlay portion 41 in the Z- direction (refer to FIG. 8 and FIG. 9). The extra portion 43 extends from the X+ direction end of the underlay portion 41 in the Z- direction (refer to FIG. 8 and FIG. 9).

As shown in FIG. 4, the sheet 40 is formed by layers laminated together, and includes a back surface layer 40A and a front surface layer 40B. Hereinafter, the surface of the sheet 40 including the surface of the underlay portion 41 in the Z- direction is referred to as the “back surface of the sheet 40,” and the surface of the sheet 40 including the surface of the underlay portion 41 in the Z+ direction is referred to as the “front surface of the sheet 40.” The back surface layer 40A constitutes the reverse side of the sheet 40. The front surface layer 40B is laminated on top of the back surface layer 40A and constitutes the front surface of the sheet 40.

The back surface layer 40A is not limited to a specific material, but, in this embodiment, the back surface layer 40A is polyurethane fabric. The front surface layer 40B is not limited to a specific material, but in this embodiment, the front surface layer 40B is a water-repellent treated fabric, specifically polyester. The coefficient of friction of the back surface layer 40A (polyurethane fabric) is greater than that of the front surface layer 40B (polyethylene fabric).

The front surface of the sheet 40 (water-repellent treated fabric) is water-repellent. That is, the contact angle between the front surface of the sheet 40 and water is 90° or greater. Therefore, the sheet 40 is essentially non-absorbent, so moisture is less likely to penetrate from the front surface to the back surface of the sheet 40 in the Z-direction. A plastic film, for example, may be adopted as the sheet 40 as a member that is water-repellent and essentially non-absorbent.

As shown in FIG. 3, the support member 50 is disposed at the X- direction end of the underlay portion 41 and supports the underlay portion 41 from the Z- direction. The support member 50 has a rod shape extending in the Y direction, and extends in the Y+ direction beyond the Y+ direction end of the underlay portion 41. The support member 50 includes extension portions 51 and 52. The extension portion 51 has a rectangular tube shape extending in the Y direction, and is disposed on a portion of the support member 50 that is in the Y- direction. The extension portion 52 has a rectangular prism shape extending in the Y direction and is inserted into the extension portion 51. The length of the extension portions 51 and 52 in the Z direction is greater than the thickness of the sheet 40.

The two enlarged views in FIG. 3 show cross-sectional views taken along a plane orthogonal to the Z direction at joint portions of the extension portions 51 and 52, respectively. The upper of the two enlarged views in FIG. 3 shows a long state S1, which will be described later. The lower of the two enlarged views in FIG. 3 shows a short state S2, which will be described later. Hereinafter, a line extending in the Y direction and passing through the intersection point of the diagonals of the cross-section (rectangle) obtained by cutting the extension portions 51 and 52 along a plane orthogonal to the Y direction is referred to as centerline C.

An engagement portion 511 is disposed at the end of the extension portion 51 in the Y+ direction. The engagement portion 511 protrudes from the Y+ direction end of the extension portion 51 toward the direction approaching the centerline C. Stoppers 521 and 522 are disposed one at each end of the extension portion 52 in the Y-direction. The stoppers 521 and 522 protrude from one from each end in the Y-direction of the extension portion 52 in directions away from the central axis C. Therefore, when the extension portion 52 attempts to withdraw from the extension portion 51, the stopper 521 catches on the engagement portion 511. When the entire extension portion 52 attempts to enter the extension portion 51, the stopper 522 catches on the engagement portion 511. As described above, the extension portion 52 is connected to the extension portion 51 so as to be able to extend and contract in the Y-direction.

The support member 50 is switchable between the long state S1 and the short state S2. The long state S1 is a state in which the stopper 521 is caught on the engagement portion 511. The short state S2 is a state in which the stopper 522 is caught on the engagement portion 511.

Hereinafter, the length in the Y direction from the Y- end to the Y+ direction end of the support member 50 is referred to as the “length L of the support member 50.” In the present embodiment, the end of the support member 50 in the Y- direction constitutes the end of the extension portion 51 in the Y- direction in both the long state S1 and the short state S2, while the end of the support member 50 in the Y+ direction constitutes the end of the extension portion 52 in the Y+ direction in both the long state S1 and the short state S2. In the long state S1, the length L of the support member 50 is a first length. In the short state S2, the length L of the support member 50 is a second length, which is shorter than the first length.

The sheet 40 is fixed to the support member 50 by one or more fasteners 91 (two in the present embodiment). In the present embodiment, the fastener 91 is a rivet, which is inserted from the X- direction through the extra portion 42 into the extension portion 51.

The support member 60 is disposed at the X+ direction end of the underlay portion 41 and supports the underlay portion 41 from the Z- direction. The structure of the support member 60 is the same as that of the support member 50. Therefore, the description of the structure of the support member 60 will be simplified. The support member 60 includes extension portions 61 and 62. The extension portion 61 corresponds to the extension portion 51, and the extension portion 62 corresponds to the extension portion 52. Similarly to the support member 50, the support member 60 can also be switched between the long state S1 and the short state S2.

The sheet 40 is fixed to the support member 60 by one or more fasteners 92. In the present embodiment, the fastener 92 is a rivet, which is inserted into the extension portion 61 from the X+ direction through the extra portions 43.

The support member 70 is disposed only at the end in the Y- direction of each of the support members 50 and 60, among the ends of support members 50 and 60 in the Y+ direction and the Y- direction. The support member 70 has a V-shape that opens in the Y+ direction when viewed from the Z direction, and includes extension portions 71 and 72. The extension portion 71 extends toward the Y- direction as the extension portion 71 extends from the end of the support member 50 in the Y- direction toward the X+ direction, all the way to the center in the X direction between the support member 50 and the support member 60.

The extension portion 71 has a bent plate-like shape. In the present embodiment, the end of the extension portion 71 in the Y- direction protrudes in the Z- direction. The length of the extension portion 71 in the Z direction is greater than the thickness of the sheet 40.

The extension portion 72 extends toward the Y- direction as the extension portion 72 extends from the end of the support member 60 in the Y- direction toward the X- direction, all the way to the center in the X direction between the support members 50 and 60. The extension portion 72 has a bent plate-like shape. The end of the extension portion 72 in the Y- direction protrudes in the Z- direction. The length of the extension portion 72 in the Z direction is greater than the thickness of the sheet 40.

A connecting mechanism of the support members 50, 60, and 70 will now be described. The extension portion 71 and the support member 50 are connected together by a connector 81. The extension portions 72 and the support member 60 are connected to together by a connector 82. The extension portions 71 and 72 are connected together by a connector 83.

Each of the connectors 81, 82, and 83 is a shaft extending in the Z direction. Axes AX1, AX2, and AX3 pass through the centers of the connectors 81, 82, and 83, respectively, and extend in the Z direction. The support member 50 and the extension portion 71 are rotatable relative to each other about the axis AX1. The support member 60 and the extension portion 72 are rotatable relative to each other about the axis AX2. The extension portion 71 and the extension portion 72 are rotatable relative to each other about the axis AX3.

In the present embodiment, the rigidity of each of the support members 50, 60, and 70 is higher than that of the sheet 40. The materials of the support members 50, 60, and 70 are not limited to specific materials as long as the rigidity of the support members 50, 60, and 70 exceeds that of the sheet 40, and may, for example, be plastic, metal, or wood.

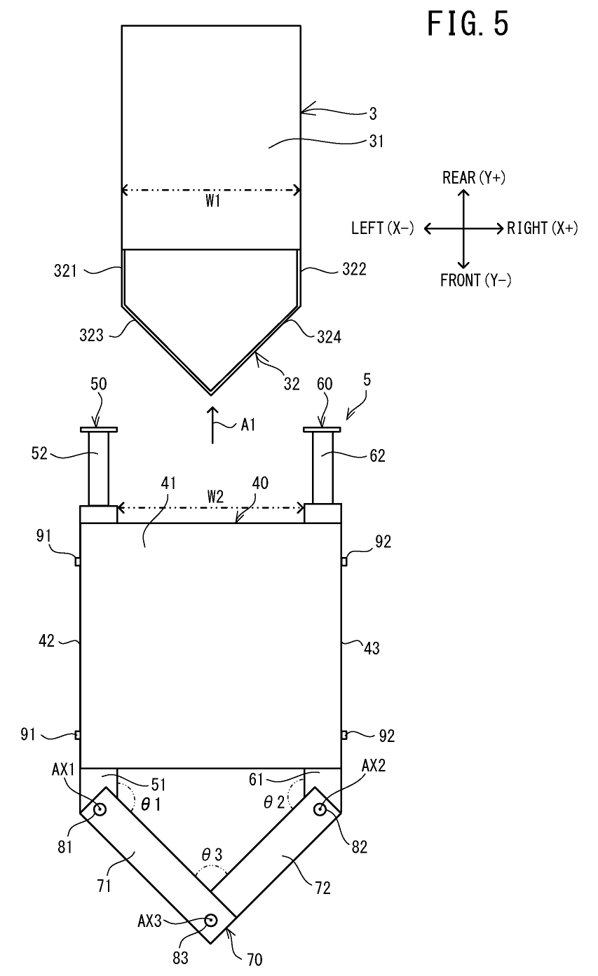

A method for using the auxiliary member 5 will now be described with reference to FIG. 5 to FIG. 9. As shown in FIG. 5, a user uses the auxiliary member 5 in the long state S1, for example. With the sheet 40 detached from the support members 50 and 60, the user rotates the extension portions 71 and 72 relative to each other around the axis AX3. The user rotates the support member 50 and the extension portion 71 relative to each other around the axis AX1, and also rotates the support member 60 and the extension portion 72 relative to each other around the axis AX2, so that the support members 50 and 60 become parallel to each other. By doing this, the user adjusts the distance W2 between the support members 50 and 60 in the X direction so that it approximates the width W1 of the platen 3.

For example, to reduce the distance W2 between the support members 50 and 60, the user decreases an angle θ3 between the extension portions 71 and 72, and increases both an angle θ1 between the support member 50 and the extension portion 71, and an angle θ2 between the support member 60 and the extension portion 72. To increase the distance W2 between the support members 50 and 60, the user increases the angle θ3 between the extension portions 71 and 72, and decreases both the angle θ1 between the support member 50 and the extension portion 71, and the angle θ2 between the support member 60 and the extension portion 72.

The user fixes the sheet 40 to the support members 50 and 60 using the fasteners 91 and 92. For example, in a case where the platen 3 is small, the extra portions 42 and 43 are larger (refer to FIG. 9). In this case, the user may secure the sheet 40 to the support member 50 with the fastener 91 while the extra portion 42 is wound around the support member 50, and secure the sheet 40 to the support member 60 with the fastener 92 while the extra portion 43 is wound around the support member 60.

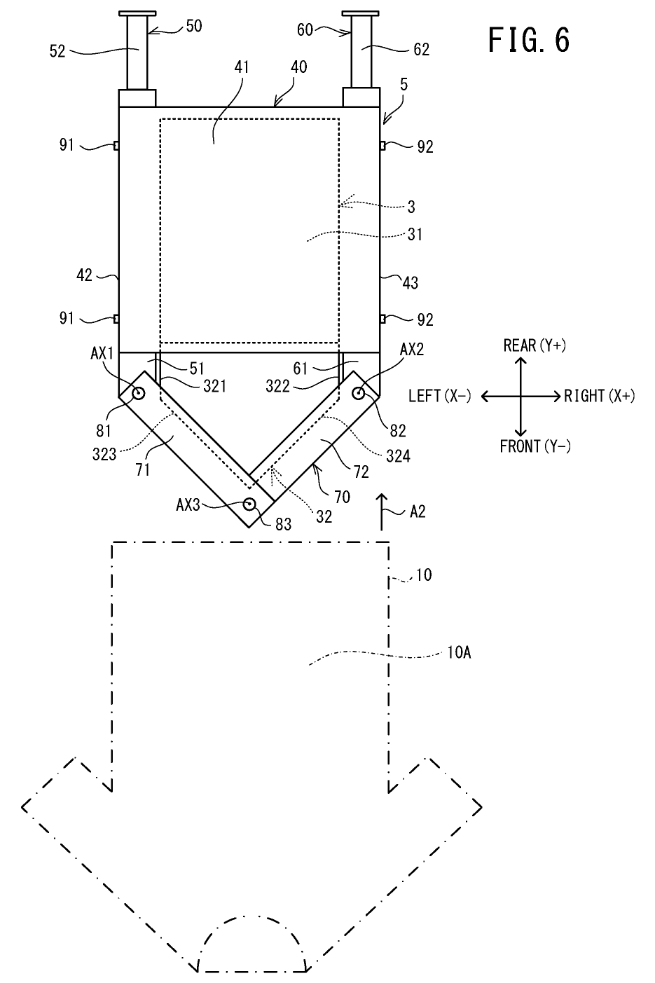

As shown in FIG. 5 and FIG. 6, the user mounts the auxiliary member 5 from the front onto the platen 3 with the platen 3 positioned at the set position P1 shown in FIG. 2 (refer to the arrow A1 shown in FIG. 5). More specifically, the auxiliary member 5 is mounted to the platen 3 such that the Z+ direction of the auxiliary member 5 faces upward relative to the platen 3, and the Y+ direction of the auxiliary member 5 faces rearward relative to the platen 3.

For example, the user pushes the auxiliary member 5 rearward with respect to the platen 3 until the support member 70 comes into contact with the support portion 32. As a result, the auxiliary member 5 is positioned with respect to the platen 3 in the front-rear direction.

As shown in FIG. 8 and FIG. 9, in a state where the auxiliary member 5 is mounted to the platen 3, the underlay portion 41 is positioned on the placement surface 31 of the platen 3. The back surface layer 40A constitutes the lower surface of the underlay portion 41, and comes into contact with the placement surface 31 of the platen 3. The front surface layer 40B forms the upper surface of the underlay portion 41. Because the sheet 40 is flexible, the underlay portion 41 generally conforms to the placement surface 31 of the platen 3.

The support member 50 is located to the left of the platen 3, arranged near the left end of the platen 3, and positioned below the underlay portion 41. Accordingly, the lower end of the support member 50 is positioned below the placement surface 31 of the platen 3. The support member 60 is located to the right of the platen 3, arranged near the right end of the platen 3, and positioned below the underlay portion 41. Accordingly, the lower end of the support member 60 is positioned below the placement surface 31 of the platen 3.

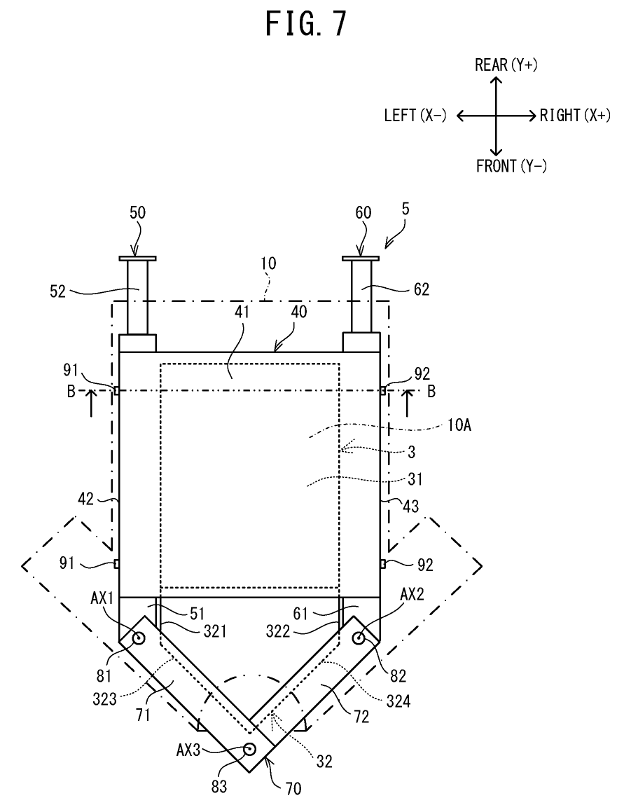

As shown in FIG. 6 and FIG. 7, with the auxiliary member 5 mounted to the platen 3, the user sets the T-shirt 10 onto the platen 3 from the front (refer to arrow A2 in FIG. 6). More specifically, the T-shirt 10 is set on the platen 3 with the print surface 10A of the T-shirt 10 facing upward and the neck portion of the T-shirt 10 oriented forward.

As shown in FIG. 8 and FIG. 9, in a state where the T-shirt 10 is set on the platen 3, the platen 3 is inserted into the T-shirt 10 and the print surface 10A of the T-shirt 10 is arranged on the underlay portion 41. Accordingly, the underlay portion 41 is positioned between the placement surface 31 of the platen 3 and the print surface 10A of the T-shirt 10, in the up-down direction. The front surface layer 40B comes into contact with the T-shirt 10.

As shown in FIG. 7, in the state where the T-shirt 10 is set on the platen 3, the extension portions 71 and 72 are arranged so as to follow along both shoulder portions of the T-shirt 10. The connecting portions with the extension portions 71 and 72 protrude forward from the neck portion of the T-shirt 10. The end of the body of the T-shirt 10 that is opposite the neck portion is supported by portions of the support members 50 and 60 that are farther in the Y+ direction than the Y+ direction end of the sheet 40.

With the T-shirt 10 set on the platen 3, the user inputs a print start instruction to the printer 1. The printer 1 conveys the platen 3 from the set position P1 shown in FIG. 2 to the print position P2, and performs wet-on-wet printing or wet-on-dry printing. After the wet-on-wet printing or wet-on-dry printing is completed, the printer 1 conveys the platen 3 from the print position P2 to the set position P1. The user then removes the printed T-shirt 10 from the platen 3 together with the auxiliary member 5.

For example, the user may transport the T-shirt 10, in a state attached to the auxiliary member 5, to a post-treatment device. In the post-treatment device, the T-shirt 10, together with the auxiliary member 5, is arranged such that the Z+ direction of the auxiliary member 5 faces upward (that is, the print surface 10A of the T-shirt 10 faces upward). The post-treatment device is, for example, an oven, which dries the print surface 10A of the T-shirt 10 with heat to improve the fixation of the ink.

In a case where the image printed on the T-shirt 10 is small, for example, the user may switch the support members 50 and 60 from the long state S1 to the short state S2 and then place the T-shirt 10 together with the auxiliary member 5 into the post-treatment device. In a case where the image printed on the T-shirt 10 is large, for example, the user may place the T-shirt 10 together with the auxiliary member 5 into the post-treatment device, while maintaining the support member 50 and 60 in the long state S1.

As described above, according to the above-described embodiment, the support members 50, 60, and 70 are each positioned below the underlay portion 41 of the sheet 40 in the state where the auxiliary member 5 is mounted to the platen 3. Therefore, if the underlay portion 41 attempts to shift with respect to the platen 3, the support members 50, 60, or 70 will come into contact with the peripheral edge of the platen 3. Because the rigidity of the support members 50, 60, and 70 is higher than that of the sheet 40, contact between each support member and the platen 3 more readily restricts misalignment of the underlay portion 41 relative to the platen 3 than in cases where the rigidity of the support members is lower than that of the sheet 40. Therefore, the auxiliary member 5 contributes to suppressing misalignment of the underlay portion 41 relative to the platen 3.

In the above-described embodiment, the coefficient of friction of the lower surface (back surface layer 40A) of the underlay portion 41 in the state where the auxiliary member 5 is mounted to the platen 3 is greater than the coefficient of friction of the upper surface (front surface layer 40B) of the underlay portion 41 in the state where the auxiliary member 5 is mounted to the platen 3. Therefore, misalignment of the underlay portion 41 with respect to the platen 3 is suppressed by the friction generated between the lower surface of the underlay portion 41 and the placement surface 31 of the platen 3 in the state where the auxiliary member 5 is mounted to the platen 3. Accordingly, the auxiliary member 5 contributes to suppressing misalignment of the underlay portion 41 relative to the platen 3. Furthermore, because the coefficient of friction of the upper surface (front surface layer 40B) of the underlay portion 41 is relatively low in the state where the auxiliary member 5 is mounted to the platen 3, in a case where the T-shirt 10 is set on the auxiliary member 5, the T-shirt 10 is less likely to catch on the upper surface of the underlay portion 41. Accordingly, it is easy for the user to set the T-shirt 10 on the auxiliary member 5.

In the above-described embodiment, each of the support members 50 and 60 can be selectively switched between the long state S1 and the short state S2. In a case where the area to be printed on the print surface 10A of the T-shirt 10 is small, for example, the support members 50 and 60 may each be switched from the long state S1 to the short state S2. Accordingly, the auxiliary member 5 contributes to a reduction in size according to the application. For example, the auxiliary member 5 contributes to accommodating a larger number of T-shirts 10, together with the auxiliary member 5, in the post-treatment device.

In the above-described embodiment, in the state where the auxiliary member 5 is mounted to the platen 3, the upper surface of the underlay portion 41 is water-repellent. Accordingly, as compared to a case where the upper surface of the underlay portion 41 is not water-repellent, the auxiliary member 5 contributes to helping prevent the placement surface 31 of the platen 3 from becoming dirty. Furthermore, because the pretreatment agent or water vapor for humidifying the printing region R, for example, is less likely to pass through the underlay portion 41, the amount of the pretreatment agent or water vapor present above the upper surface of the underlay portion 41 tends to remain constant. Accordingly, the auxiliary member 5 contributes to suppressing deterioration in print quality on the print surface 10A of the T-shirt 10.

In the above-described embodiment, the sheet 40 is substantially non-absorbent. Therefore, compared to the case where the sheet 40 is absorbent, the auxiliary member 5 contributes to inhibiting moisture absorbed by the sheet 40 from affecting the next T-shirt 10 to be printed. The moisture refers, for example, to the pretreatment agent, water vapor for humidifying the printing region R, or mist generated as ink is discharged from the inkjet heads 9. Furthermore, in the state where the auxiliary member 5 is mounted to the platen 3, the amount of pretreatment agent or water vapor present above the upper surface of the underlay portion 41 tends to remain constant. Accordingly, the auxiliary member 5 contributes to suppressing deterioration in print quality on the print surface 10A of the T-shirt 10.

In the above-described embodiment, the extension portion 71 extends toward the Y- direction as the extension portion 71 extends from the Y- direction end of the support member 50 toward the X+ direction. The extension portion 72 extends toward the Y- direction as the extension portion 71 extends from the Y- direction end of the support member 60 toward the X- direction. Accordingly, the extension portions 71 and 72 are arranged so as to follow along both shoulder portions of the T-shirt 10. Accordingly, the auxiliary member 5 contributes to suppressing misalignment of the T-shirt 10 relative to the underlay portion 41.

In the above-described embodiment, the auxiliary member 5 includes the connectors 81, 82, and 83. Accordingly, by rotating the support member 50 and the extension portion 71 around the axis AX1, rotating the support member 60 and the extension portion 72 around the axis AX2, and rotating the extension portion 71 and the extension portion 72 around the axis AX3, the distance W2 between the support members 50 and 60 changes in the X direction. Accordingly, the auxiliary member 5 contributes to adjusting the distance W2 between the support members 50 and 60 in the X direction, for example, to match the size of the platen 3.

In the above-described embodiment, the support members 50 and 60 each extend in the Y+ direction beyond the Y+ direction end of the underlay portion 41. Therefore, for example, in a case where the print surface 10A of the T-shirt 10 is larger than the underlay portion 41 in the Y direction, the print surface 10A of the T-shirt 10 is supported by the portions of the support members 50 and 60 that extend farther in the Y- direction from the Y- direction end of the underlay portion 41. As a result, sagging of the print surface 10A of the T-shirt 10 from the Y- direction end of the underlay portion 41 is inhibited, thus suppressing the T-shirt 10 from shifting with respect to the underlay portion 41 due to the weight of the T-shirt 10 itself. Accordingly, the auxiliary member 5 contributes to suppressing misalignment of the T-shirt 10 relative to the underlay portion 41.

In the above-described embodiment, the T-shirt 10 is an example of the “print medium” of the present disclosure. The print surface 10A is an example of the “print surface” of the present disclosure. The platen 3 is an example of the “platen” of the present disclosure. The placement surface 31 is an example of the “placement surface” of the present disclosure. The set position P1 is an example of the “set position” of the present disclosure. The inkjet head 9 is an example of the “inkjet head” of the present disclosure. The nozzle surface 90 is an example of the “nozzle surface” of the present disclosure. The up-down direction of the printer 1 is an example of the “up-down direction” of the present disclosure. The print position P2 is an example of the “print position” of the present disclosure. The auxiliary member 5 is an example of the “auxiliary member” of the present disclosure. The Z direction of the auxiliary member 5 is an example of the “first direction” of the present disclosure. The underlay portion 41 of the sheet 40 is an example of the “sheet” of the present disclosure. The Y direction of the auxiliary member 5 is an example of the “second direction” of the present disclosure. The X direction of the auxiliary member 5 is an example of the “third direction” of the present disclosure. The X- direction of the auxiliary member 5 is an example of the “third specific direction” of the present disclosure. The support member 50 is an example of the “first support member” of the present disclosure. The X+ direction of the auxiliary member 5 is an example of the “third opposite direction” of the present disclosure. The support member 60 is an example of the “second support member” of the present disclosure. The support member 70 is an example of the “third support member” of the present disclosure.

The long state S1 is an example of the “first state” of the present disclosure. The short state S2 is an example of the “second state” of the present disclosure. The Y- direction of the auxiliary member 5 is an example of the “second specific direction” of the present disclosure. The extension portion 71 is an example of the “first extension portion” of the present disclosure. The extension portion 72 is an example of the “second extension portion” of the present disclosure. The axis AX1 is an example of the “first axis” of the present disclosure. The connector 81 is an example of the “first connector” of the present disclosure. The axis AX2 is an example of the “second axis” of the present disclosure. The connector 82 is an example of the “second connector” of the present disclosure. The axis AX3 is an example of the “third axis” of the present disclosure. The connector 83 is an example of the “third connector” of the present disclosure. The Y+ direction of the auxiliary member 5 is an example of the “second opposite direction” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below. The auxiliary member 5 may be used in a printer different from the above-described embodiment, provided that the inkjet printer can transport the platen 3 between the set position P1 and the print position P2. For example, the auxiliary member 5 may be used in the printer 1 capable of performing only one of wet-on-wet printing or wet-on-dry printing. The auxiliary member 5 may also be used in the printer 1 that includes the single inkjet head 9.

The method of using the auxiliary member 5 is not limited to the above-described embodiment. For example, the user may set the T-shirt 10 on the auxiliary member 5 and then mount the auxiliary member 5, with the T-shirt 10 set thereon, to the platen 3.

The shapes of the support members 50 and 60 are not limited to those in the above-described embodiment. For example, the support member 50 may have a plate-like shape extending in the Y and Z directions. The shape of the support member 70 is not limited to the above-described embodiment. For instance, the support member 70 may have a rod shape. The support member 70 may extend linearly in the X direction between the Y- direction end of the support member 50 and the Y- direction end of the support member 60.

In the above-described embodiment, the support member 70 is disposed only at the Y- direction end, among the Y- direction end and Y+ direction end, of each of the support members 50 and 60. In contrast, the support member 70 may be disposed only at the Y+ direction end, among the Y- direction end and the Y+ direction end, of each of the support members 50 and 60. The support member 70 may be disposed at both the Y- direction end and the Y+ direction end of each of the support members 50 and 60.

The connector 81 may connect the extension portion 71 and the support member 50 in a non-rotatable manner (i.e., fixedly). In this case, the connector 81 is not limited to a shaft, but may alternatively be a fixing plate or an adhesive, for example. The extension portion 71 and the support member 50 may be integrally formed as a single piece. Similarly, the connectors 82 and 83 may also be modified in the same manner as the connector 81. The relationship between the extension portion 72 and the support member 60, as well as the relationship between the extension portions 71 and 72, may likewise be modified in the same manner as the relationship between the extension portion 71 and the support member 50.

The X+ direction end of the extension portion 71 and the X- direction end of the extension portion 72 may be separated from each other in the X direction. In this case, the extension portions 71 and 72 may be connected to each other via another extension portion. For example, the other extension portion extends in the X direction. Furthermore, the X- direction end of the other extension portion is rotatably connected to the extension portion 71 by a connector, and the X+ direction end of the other extension portion is rotatably connected to the extension portion 72 by a connector. In this case, the other extension portion and the two connectors are an example of the “third connector” of the present disclosure.

In the above-described embodiment, for example, the sheet 40 may be absorbent. Paper, for example, may be used as an absorbent material for the sheet 40. For example, the surface of the sheet 40 need not necessarily be water-repellent. In a case where the surface of the sheet 40 is not water-repellent and the sheet 40 as a whole is non-absorbent, for example, moisture readily passes through the sheet 40 from the front surface to the back surface in the Z direction.

The connecting structure of the extension portions 51 and 52 is not limited to the above-described embodiment. For example, the extension portions 51 and 52 may be connected by a hinge. In this case, the extension portion 52 switches between a state in which the extension portion 52 is aligned in a straight line with the extension portion 51 and a state in which the extension portion 52 is folded relative to the extension portion 51 about the axis of the hinge. The state in which the extension portion 52 is aligned in a straight line with the extension portion 51 is defined as the long state S1. The state in which the extension portion 52 is folded relative to the extension portion 51 about the axis of the hinge is defined as the short state S2. The support member 50 may be made incapable of switching between the long state S1 and the short state S2. In this case, the extension portion 52 of the support member 50 may be omitted. The support member 60 may be modified similarly to the support member 50.

In the above-described embodiment, the coefficient of friction of the back surface of sheet 40 may be the same as that of the front surface of the sheet 40, or it may be smaller than the coefficient of friction of the front surface of the sheet 40. The sheet 40 may be a single layer, for example. That is, either the back surface layer 40A or the front surface layer 40B may be omitted. In this case, the coefficient of friction of the back surface of the sheet 40 becomes the same as that of the front surface of the sheet 40. For example, the coefficient of friction on the back surface of the sheet 40 may be made to differ from that on the front surface of the sheet 40 by forming the back surface layer 40A and the front surface layer 40B of the same material but with a different fabric weave. The fabric weave may be a plain weave or a pile weave, for example.

In the above-described embodiment, the extra portions 42 and 43 of the sheet 40 may be omitted. The fasteners 91 and 92 are not limited to rivets and may be bolts and nuts, screws, for example. The sheet 40 may be adhered to the support members 50 and 60, for example, by an adhesive instead of the fasteners 91 and 92. The sheet 40 need not be flexible and may be a thin plate, for example.

In the above-described embodiment, the support members 50 and 60 extend parallel to each other. The support members 50 and 60 preferably extend along the direction in which the left end and the right end of the platen 3 extend. That is, in a case where the left and right ends of the platen 3 extend in directions away from each other in the left-right direction as they extend from the front toward the rear, for example, the support members 50 and 60 preferably extend in directions away from each other in the X direction as they extend from the Y- direction toward the Y+ direction.

What is claimed is:

1. An auxiliary member configured to be mounted to a platen, the platen being configured to be conveyed between a set position and a print position, the set position being a position where a print surface of a print medium is placed on a placement surface that is an upper surface of the platen, the print position being a position where the placement surface of the platen faces, in an up-down direction, a nozzle surface of an inkjet head, with the print surface of the print medium between the placement head of the platen and the nozzle surface of the inkjet head, the auxiliary member comprising:
a sheet extending in a plane intersecting a first direction;
a first support member extending in a second direction intersecting the first direction, the first support member being disposed at an end of the sheet in a third specific direction, the third specific direction being one of a third direction intersecting the first direction and the second direction, the first support member supporting the sheet and having a higher rigidity than the sheet;
a second support member extending in the second direction, the second support member being disposed at an end of the sheet in a third opposite direction, the third opposite direction being opposite to the third specific direction in the third direction, the third support member supporting the sheet and having a higher rigidity than the sheet; and
a third support member extending toward a single point in the third direction from both the first support member and the second support member, the single point being disposed between the first support member and the second support member, the third support member supporting the sheet and having a higher rigidity than the sheet, wherein
the auxiliary member is configured to be mounted to the platen with the first direction oriented along the up-down direction,
the sheet is disposed between the placement surface of the platen and the print surface of the print medium in the up-down direction, in a state where the auxiliary member is mounted to the platen, and
the first support member, the second support member, and the third support member are positioned below the sheet, in the state where the auxiliary member is mounted to the platen.

2. The auxiliary member according to claim 1, wherein
a coefficient of friction on a lower surface of the sheet in the state where the auxiliary member is mounted to the platen is greater than a coefficient of friction on an upper surface of the sheet in the state where the auxiliary member is mounted to the platen.

3. The auxiliary member according to claim 1, wherein
the first support member and the second support member are each switchable between a first state and a second state, the first state being a state in which the respective lengths of the first support member and the second support member in the second direction are a first length, the second state being a state in which the respective lengths of the first support member and the second support member in the second direction are a second length shorter than the first length.

4. The auxiliary member according to claim 1, wherein
an upper surface of the sheet, in the state where the auxiliary member is mounted to the platen, is water-repellent.

5. The auxiliary member according to claim 1, wherein
the sheet is substantially non-absorbent.

6. The auxiliary member according to claim 1, wherein
the third support member includes
a first extension portion extending toward the second specific direction as the first extension portion extends from an end of the first support member in a second specific direction toward the third opposite direction, the second specific direction being one of the second direction, and
a second extension portion extending toward the second specific direction as the second extension portion extends from an end of the second support member in the second specific direction toward the third specific direction.

7. The auxiliary member according to claim 6, further comprising:
a first connector connecting the first support member and the first extension member to each other in a manner rotatable about a first axis, the first axis being extending in the first direction and passing through a location where the first support member and the first extension member are connected;
a second connector connecting the second support member and the second extension member to each other in a manner rotatable about a second axis, the second axis being extending in the first direction and passing through a location where the second support member and the second extension member are connected; and
a third connector connecting the first extension member and the second extension member to each other in a manner rotatable about a third axis, the third axis being extending in the first direction and passing through a location where the first extension member and the second extension member are connected.

8. The auxiliary member according to claim 1, wherein
the first support member and the second support member each extend toward a second opposite direction beyond an end of the sheet in the second opposite direction, the second opposite direction being opposite to a second specific direction, the second specific direction being one of the second direction.
